(19) United States
(12) Patent Application Publication
(10) Pub. No.: US 2012/0037075 A1
(43) Pub. Date: Feb. 16, 2012

(54) COATING APPRATUS HAVING CONCENTRATION SENSOR

(75) Inventor: SHAO-KAI PEI, Tu-Cheng (TW)

(73) Assignee: HON HAI PRECISION INDUSTRY CO., LTD., Tu-Cheng (TW)

(21) Appl. No.: 12/943,011

(22) Filed: Nov. 10, 2010

(30) Foreign Application Priority Data
Aug. 16, 2010 (TW) 99127372

(51) Int. Cl. B05C 11/00

(52) U.S. Cl. 118/696

(57) ABSTRACT

A coating apparatus includes an atomization chamber, a reaction chamber having an opening, an outputting chamber successively connected with each other. The coating apparatus also includes a gate, a concentration sensor and a control device. The atomization chamber atomizes a precursor. The reaction chamber receives a reactive gas for reacting with the atomized precursor. The gate is movable between a first position where the opening is closed by the gate and a second position where the opening is disengaged from the gate. The concentration sensor is located in the reaction chamber and senses a concentration of a product obtained in the reaction chamber. The control device is electrically connected with the concentration sensor, configured for comparing the concentration sensed by the concentration sensor with a prestored concentration value, and controlling the gate to move to the second position if the sensed product concentration is equal to the prestored concentration value.

### BACKGROUND

1. Technical Field

The present disclosure relates to chemical vapor deposition technology, and particularly, to a coating apparatus having a concentration sensor.

2. Description of Related Art

For a traditional chemical vapor deposition, droplets concentration is one of the most important factors affecting thickness uniformity of a coating layer. Therefore, it is necessary to provide a coating apparatus having a concentration sensor for sensing the droplets concentration.

### BRIEF DESCRIPTION OF THE DRAWINGS

Many aspects of the present coating apparatus can be better understood with reference to the following drawings. The components in the drawings are not necessarily drawn to scale, the emphasis instead being placed upon clearly illustrating the principles of the presentment coating apparatus. Moreover, in the drawings, like reference numerals designate corresponding parts throughout the views.

FIG. 1 is an isometric and cross-sectional view of a coating apparatus in accordance with an exemplary embodiment of the present disclosure.

### DETAILED DESCRIPTION

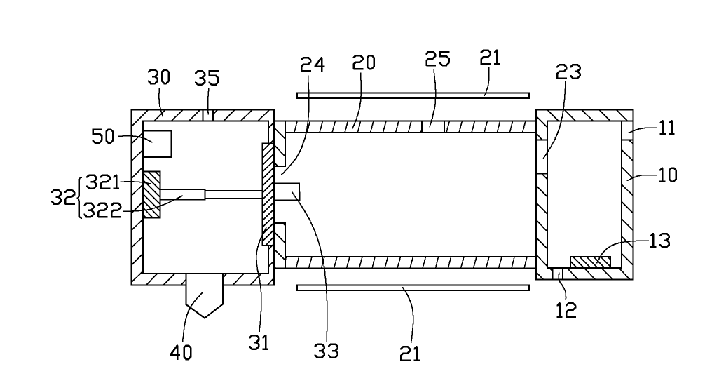

Referring to FIG. 1, a coating apparatus 100 provided in an exemplary embodiment of the present disclosure is shown. The coating apparatus 100 includes an atomization chamber 10, a reaction chamber 20, an outputting chamber 30 successively communicating with each other. In addition, the coating apparatus 100 further includes a plate-shaped gate 31, a control device 50, and a nozzle 40.

In particular, the atomization chamber 10 has a precursor inlet 11 and a carrying gas inlet 12. The precursor inlet 11 and the carrying gas inlet 12 are respectively defined at the bottom and a sidewall of the atomization chamber 10. The atomization chamber 10 employs an ultrasonic vibration device 13 mounted on the bottom thereof. The ultrasonic vibration device 13 generates ultrasonic waves to atomize the precursor. The atomization chamber 10 also defines an outlet 23 on the sidewall, the outlet 23 is opposite to the precursor inlet 11, and is closer to the carrying gas inlet 12 than the precursor inlet 11.

The reaction chamber 20 is hollow cylindrical, and has an opening 24 opposite to the outlet 23. The reaction chamber 20 communicates with the atomization chamber 10 through the outlet 23, and communicates with the outputting chamber 30 through the opening 24. A heating device 21 surrounds the reaction chamber 20 for heating the reactive chamber 20 to a predetermined temperature. The reaction chamber 20 defines a reactive gas introduction hole 25 for introducing reactive gas thereinto.

The outputting chamber 30 includes a driving device 32 consisting of a driver 321 and a spindle 322, and a concentration sensor 33. One end of the spindle 322 is connected with the driver 321, and the another end of the spindle 322 is connected with the gate 31. The spindle 322 is capable of changing its length with assistance from the driver 321, and keeping the changed length when the driver 321 stops. As such, the gate 31 is movable relative to the opening 24 of the reaction chamber 20. In other words, when the gate 31 reaches the opening 24 (defined as a first position), the opening 24 is closed, and the reaction chamber 20 and the outputting chamber 30 are separated from each other. When the gate 31 just moves away from the opening 24 (defined as a second position), i.e., the opening 24 is disengaged from the gate 31, the reaction chamber 20 communicates with the outputting chamber 30. The concentration sensor 33 is mounted on a surface of the gate 31, which is adjacent to the reaction chamber 20. The concentration sensor 33 senses the resultant product concentration in the reaction chamber 20 and transferring the sensed concentration to the control device 50. In other embodiments, the concentration sensor 33 is mounted on an inner surface of the reaction chamber 20, or partially inserts into the reaction chamber 20. Additionally, the outputting chamber 30 defines an inertia gas introduction hole 35 on the top wall thereof. The nozzle 40 is mounted on the outputting chamber 30 and aligned with the inertia gas introduction hole 35.

The control device 50 is electrically connected with the heating device 21, the driving device 32 and the concentration sensor 33. The control device 50 controls the heating device 21 to heat the reaction chamber 20 to a predetermined temperature and pressure. The predetermined temperature and the pressure are prestored in the control device 50. The control device 50 also prestores a predetermined product concentration value, and compares the sensed concentration with the predetermined concentration value. Once the sensed concentration is equal to the predetermined concentration value, the control device 50 controls the driving device 32 to drive the gate 31 to move away from the opening 24 of the reaction chamber 20.

During an actual coating process, the gate 31 is moved till it closes the opening 24. A predetermined temperature, pressure and product concentration value are stored in the control device 50. A precursor and a carrying gas are respectively introduced into the atomization chamber 10 through the precursor inlet 11 and the gas inlet 12, and the ultrasonic vibration device 13 is immersed in the precursor. It is understood that the precursor is atomized into a number of droplets. Subsequently, the droplets move into the reaction chamber 20 with the carrying gas through the outlet 23. In the present embodiment, the precursor is Zinc oxide solution, the carrying gas is nitrogen gas with an introduction speed ranged from about 30 to about 100 ml/min, and a vibration frequency of the ultrasonic vibration device 13 is about 2.4 MHz. A reactive gas is introduced into the reaction chamber 20 at a uniform speed through the reactive gas introduction hole 25. The reactive chamber 20 is heated until the temperature and pressure therein are up to the predetermined temperature and pressure. A reaction occurs between the reactive gas and the droplets, and a product is resultantly produced. In the present embodiment, for improving reactive rate, the introduction speed of the reactive gas is equal to that of the carrying gas. The concentration of the product is sensed by the concentration sensor 33, and is compared with the predetermined concentration by the control device 50. Once the former is equal to the latter, the driving device 32 is operated under a control of the control device 50. In addition, the gate 31 moves away from the opening 24. That is, the reaction chamber 20 communicates with the outputting chamber 30, and the product enters the outputting chamber 30. Since the outputting chamber 30 is cooler than the reaction chamber 20, the product is liquefied and then flows out of the outputting chamber 30 through the nozzle 40. Therefore, a coating layer can be formed on a substrate opposing the nozzle 40. For purpose of speeding up the product flow to the nozzle 40, an inertia gas is uniformly introduced into the outputting chamber 30 through the inertia gas introduction hole 35 to blow the product. In the present embodiment, the introduction speed of the inertia gas is in a range from about 10 to about 50 ml/min.

In the present embodiment, the concentration sensor 33 senses the concentration of the product in the reaction chamber 20 to retain the concentration of the product to be the predetermined concentration. In this way, the thickness uniformity of the coating layer is improved. Furthermore, a mass flow of the product into the outputting chamber 30 is adjustable by moving the gate 31 relative to the opening 24. Therefore, a thickness of the coating layer is adjustable.

It is noted that during the coating process, once the concentration sensor 33 senses that the concentration of the product in the reaction chamber 20 is less than the predetermined concentration, the control device 50 controls the driving device 32 to drive the gate 31 to seal the opening 24.

It is also noted that, in other embodiments, the atomization chamber 10 can be a typical high-pressure atomization chamber, or other well-known atomization chamber.

The embodiments described are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A coating apparatus, comprising:
an atomization chamber for containing and atomizing a liquid precursor therein;
a reaction chamber connected with the atomization chamber, the reaction chamber configured for receiving a reactive gas to react with the atomized precursor introduced from the atomization chamber, the reaction chamber including an opening;
an outputting chamber communicating with the reaction chamber through the opening;
a gate, the gate being movable between a first position where the opening is closed by the gate and a second position where the opening is disengaged from the gate;
a concentration sensor located in the reaction chamber and configured for sensing a concentration of a resultant product obtained by the reaction between the reactive gas and the atomized precursor; and
a control device electrically connected with the concentration sensor, the control device configured for comparing the concentration sensed by the concentration sensor with a prestored concentration value, and controlling the gate to move to the second position if the sensed product concentration is equal to the prestored concentration value.

2. The coating apparatus of claim 1, wherein the atomization chamber comprises an ultrasonic vibration device for generating ultrasonic waves to atomize the liquid precursor.

3. The coating apparatus of claim 1, further comprising a heating device surrounding the reaction chamber.

4. The coating apparatus of claim 1, wherein the concentration sensor is fixed on the gate.

5. The coating apparatus of claim 1, further comprising a nozzle communicating with the output chamber.

6. The coating apparatus of claim 5, wherein the output chamber defines an inertia gas introduction hole for introducing inertia gas, the hole is aligned with the nozzle.
